(19) United States
(12) Patent Application Publication
(10) Pub. No.: US 2008/0117617 A1
(43) Pub. Date: May 22, 2008

(54) Forced air cooled metallic tubular horticulture light fixture

(75) Inventors: Craig Hargreaves, Vancouver, WA (US); Darrin McDonald, Vancouver, WA (US)

Correspondence Address: ROBERT IRELAND, P.O. BOX 273, BANKS, OR, 97124, US

(73) Assignee: IP Holdings, LLC

(21) Appl. No.: 11/603,423

(22) Filed: Nov. 21, 2006

(51) Int. Cl. F21V 13/02; F21V 7/00; F21S 4/00

(52) U.S. Cl. 362/1; 362/307; 362/223

(57) ABSTRACT

A horticultural light fixture for reducing the temperature impact of the light source on growing plants, including a hollow sheet metal tube, having first and second round hollow ends and a cutaway portion on the underside open towards the plants with at least one lamp socket mounted within said metallic tube, locating the lamp over the cutaway portion, further including a reflector mounted within the metallic tube and extending out through the cutaway portion, constructed and arranged to deflect light from the lamp toward the plants, having a transparent portion fittingly attached to the reflector between the lamp and the plants being impermeable to the heated atmosphere while allowing light to pass through.

### CROSS REFERENCES TO RELATED APPLICATIONS

None

### STATEMENT REGARDING FEDERALLY SPONSORED RESEARCH OR DEVELOPMENT

This invention is not the product of any Federally Sponsored Research or Development.

### REFERENCE TO MICROFICHE APPENDIX

Not Applicable

### BACKGROUND OF THE INVENTION

1. Technical Field

The present device relates generally to horticultural and agricultural lighting systems used in developing plants in controlled growing environments.

2. Discussion of Related Art

Indoor gardens, green houses, hydroponics systems, and isolated carbon dioxide growing chambers demand careful regulation of temperature, light, hydration, nutrients, and humidity. In these controlled environments, one of the major challenges is providing adequate light intensity, while efficiently removing the heat generated by the grow lamp. A second major challenge relates to the manufacturing of the system in an economical way, utilizing inexpensive and light materials. A third major challenge in operating a horticulture light system is keeping the grow lamp within optimum temperatures in order to promote longevity.

Horticulture lighting systems depend on grow lamps as a primary light source. Commonly used grow lamps are high pressure sodium and metal halide. These grow lamps get exceptionally hot when confined in a small light fixture. The heat generated may curl new growth on plants, dry out the soil; and, if the heat is not dissipated, the grow lamp will have a reduced life span. These undesirable effects reduce yields and increase operational costs.

Several air cooled horticulture light fixture designs incorporate sheet metal enclosures in combination with a transparent shield between the grow lamp and the developing plants. The sheet metal enclosures typically absorb considerable energy during operation and contaminate the growing environment with radiated heat. This problem of energy being absorbed and then radiated was addressed by U.S. Pat. No. 6,595,662 issued in July 2003 to Wardenburg disclosing an air cooled double walled fixture wherein cooling air was introduced via conduit on one end and exhausted out the other side, and a transparent portion was located between the grow lamp and the plants allowing for light to pass while isolating the fixture from the growing environment. However, Wardenburg did not disclose or teach the fixture having a tube design allowing for straight and continuous channel of air flow to maximize the cooling effect.

U.S. Pat. No. 6,267,483 issued in July 2001 to Hembery discloses a straight and continuous channel of air flow through a transparent tube. The Hembery device isolates the grow lamp from the growing plants by centering the grow lamp within the transparent tube. Free flowing air enters one end of the fixture and free flows out the other side. The Hembery device absolutely depends on a transparent tube, and the transparent material of choice is borosilicate glass, which is heavy and expensive.

U.S. Pat. No. 6,247,830 issued in June 2001 to Winnett et al. discloses a forced air transparent tube fixture that senses the temperature of the fixture and shuts the grow lamp down if the temperature exceeds a predetermined maximum safe operating level. The Winnett device also relies on a transparent tube that must withstand high temperatures.

The tube design is desirable because of the straight channel flow of cooling atmosphere. The transparent tube designs of Hembery and Winnett allow for straight channel flow, but require a heavy and expensive tube usually made of borosilicate glass. The photometric performance of the transparent tube fixtures are lacking because of the curvature of the glass tube. A sheet metal tube combined with a flat transparent portion is more desirable as it is cheaper, weighs less, and allows light to pass through the flat surface with a minimum of distortion, deflection, and parasitic loss. Further, integration of a reflector maximizing the photometric performance is all but impossible with a glass tube because the reflector must be contained within the tube, or be attached externally to the tube.

Not one of the above discussed inventions, taken either singularly or in combination, teaches the instant invention as claimed. What is desired is a lightweight, inexpensive, and efficient fixture that will minimally heat-impact the growing environment, while promoting longevity in the grow lamp by easily passing cooling atmosphere through the fixture.

### OBJECTS AND ADVANTAGES

There are several objects and advantages of the present device:
a) to provide a horticulture light system that minimizes the heat impact of the grow lamp on the growing environment;
b) to provide a horticulture light system that allows for cooling atmosphere to be flowed into a hollow metallic tube, over the grow lamp in a straight and continuous channel, and out the other end of the hollow metallic tube to cool and promote longevity in the grow lamp;
c) to provide a thermally isolated horticulture light system that minimizes the heat contamination of the growing environment by exhausting the heated air easily through simple connection to round conduit;
d) to provide a sheet metal alternative to using a transparent tube;

Still further objects and advantages will become apparent from considerations of the ensuing description and drawings.

### SUMMARY

In accordance with the present device, a horticulture light system constructed primarily of inexpensive and light sheet metal, providing straight channel flow of cooling atmosphere over the grow lamp and through the reflector area, exhausting out the other side; thus, thermally isolating the fixture from the growing plants.

The grow lamp should be generally cylindrical in shape and smaller in diameter than the sheet metal tube and round hollow ends, thereby allowing for sufficient forced air flow over the grow lamp and through the reflector area. The sheet metal tube should be of adequate length to contain the grow lamp and the reflector be of size, shape, and location to reflect light towards the growing plants. The transparent portion should be flat and sized to match the aperture of the reflector.

The round hollow ends may be sized to match commercially available conduit, thus allowing for easy connection to a closed loop forced atmosphere cooling system.

### DESCRIPTION OF THE DRAWINGS

FIG. 1 is a perspective view of one embodiment of the Forced Air Cooled Metallic Tubular Horticulture Light Fixture;

FIG. 2 is a front side view of the embodiment of the Forced Air Cooled Metallic Tubular Horticulture Light Fixture as shown in FIG. 1;

FIG. 3 is a left side view of the embodiment of the Forced Air Cooled Metallic Tubular Horticulture Light Fixture as shown in FIG. 1;

FIG. 4 is a top view of the embodiment of the Forced Air Cooled Metallic Tubular Horticulture Light Fixture as shown in FIG. 1;

FIG. 5 is a bottom side view of the embodiment of the Forced Air Cooled Metallic Tubular Horticulture Light Fixture as shown in FIG. 1;

FIG. 6 is a component exploded view of the hollow sheet metal tube of the Forced Air Cooled Metallic Tubular Horticulture Light Fixture as shown in FIG. 1;

FIG. 7 is an exploded perspective view of the embodiment of the Forced Air Cooled Metallic Tubular Horticulture Light Fixture as shown in FIG. 1;

FIG. 8 is a perspective, side, top and end view of the hollow sheet metal tube as shown in FIG. 1;

FIG. 9 is a is a perspective, side, top and end view of the reflector as shown in FIG. 1;

FIG. 10 is a right side view of the embodiment of the Forced Air Cooled Metallic Tubular Horticulture Light Fixture as shown in FIG. 1.

### DETAILED DESCRIPTION OF THE PREFERRED EMBODIMENT

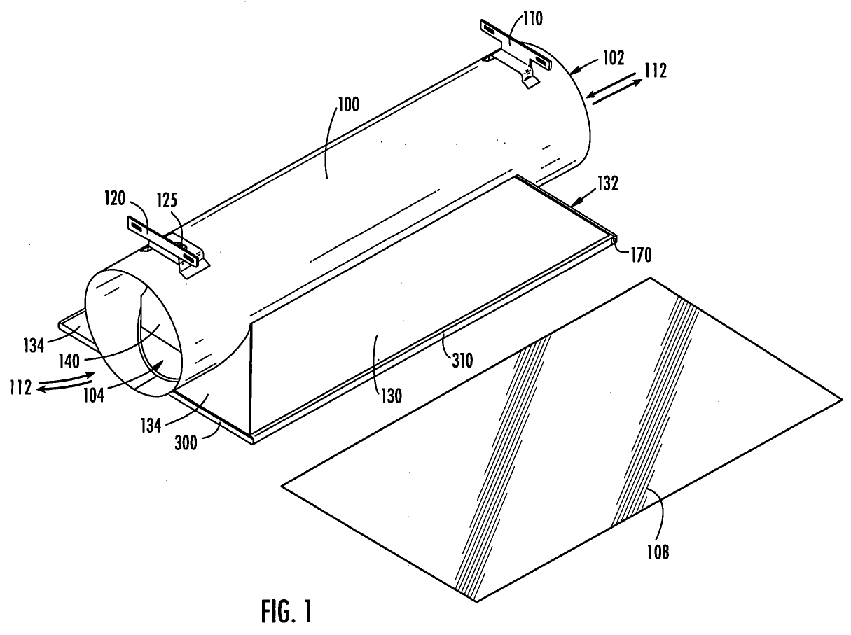

Referring now to the drawings, and particularly to FIGS. 1-10, a preferred embodiment of the present device is shown, illustrating the Forced Air Cooled Metallic Tubular Horticulture Light Fixture used in developing plants in controlled growing environments. The exemplary embodiments according to the present device are illustrated with those components necessary to demonstrate the inventive design. Many of the necessary electrical and mechanical elements for attaching, powering, and implementing are not present. For example, the electrical service connection of 110 volts and 220 volts is known by one of normal skill in the art but not specifically mentioned.

### Description FIG. 1:

FIG. 1 illustrates one embodiment of the assembled device from a perspective view having a hollow sheet metal tube 100 fittingly attached to the reflector 130. The hollow sheet metal tube 100 is preferred over a transparent tube because the hollow sheet metal tube 100 has heat shielding advantages while remaining lightweight and inexpensive. The reflector 130 reflects the light towards the plants and is thermally isolated from the growing environment by a transparent portion 108. Said transparent portion 108 is sized according to the aperture of the reflector 130, thus minimizing the amount of transparent material needed. Transparent materials are more expensive than sheet metal and tend to be heavier. Therefore, it is desirable to minimize the amount of transparent material used.

The inventor overcame the need for a heavy and expensive transparent tube by constructing the tube portion of inexpensive sheet metal. The inventor then improved the photometric properties of the fixture by integrating the reflector 130 within the hollow sheet metal tube 100, accomplishing the thermal isolation of the heated air with a transparent portion 108 that could be flat and thin; and, thus, reducing the overall cost and weight of the device. The transparent portion 108 can be constructed from inexpensive flat tempered glass and sized to match the reflector aperture, thus minimizing the amount of transparent material needed. Although flat tempered glass is preferred, the transparent portion 108 may be constructed from any material that can withstand the temperatures produced by the grow lamp, while allowing light to pass through to the growing plants.

In the preferred embodiment, said hollow sheet metal tube 100 is constructed from a single sheet of metal having a first round hollow end 102 and a second round hollow end 104. The lamp socket bracket 140 is located and attached within the sheet metal tube 100 and approximately centered within the second round hollow end 104. A first balancing suspender 110 and second balancing suspender 120 fixedly attach on the top side of the hollow sheet metal tube 100 providing structure to hang the device above the plants. A second suspender hole 125 is cut through the second suspender 120 and the sheet metal tube 100 providing an opening to the lamp socket bracket 140 for electrical connection.

The reflector 130 is shown in this embodiment being approximately centered in the hollow sheet metal tube 100. The reflector 130 is bounded by a first reflector end 132 and a second reflector end 134. The reflector 130 is open towards the plants on the bottom and sealed by a transparent portion 108. The transparent portion 108 may be constructed from any transparent material that will not melt or distort when exposed to high temperatures while allowing light to pass through to the plants. In the preferred embodiment, the transparent portion 108 is flat, and constructed of tempered glass. The reflector 130 has reflector side channels 310 bent and shaped from the long edges of the reflector 130. The reflector side channels 310 are of size and dimension matching the transparent portion 108. The second reflector end 134 has an end channel 300 bent and shaped from its bottom edge and matching the shape and dimensions of the short end of the transparent portion 108. The transparent portion 108 slides within the reflector side channels 310 fittingly inserting into the end channel 300, and held in place by the retention flap 170. In other embodiments, the transparent portion may be held by tabs, sheet metal channels, heat resistant adhesives, or other methods of affixing the transparent portion 108 between the grow lamp and the plants.

Cooling atmosphere 112 can be flowed into the first round hollow end 102 and exhausted out of the second round hollow end 104; or, oppositely, cooling atmosphere 112 can be flowed into the second round hollow end 104 and exhausted out the first round hollow end 102. Round conduit is not shown, but could be connected making a closed loop cooling system isolating the growing environment from the heated atmosphere impacted by the grow lamp. The cooling atmosphere 112 may consist of air that is introduced at a lower temperature than the grow lamp, or any other gas that will conduct heat while passing around the grow lamp.

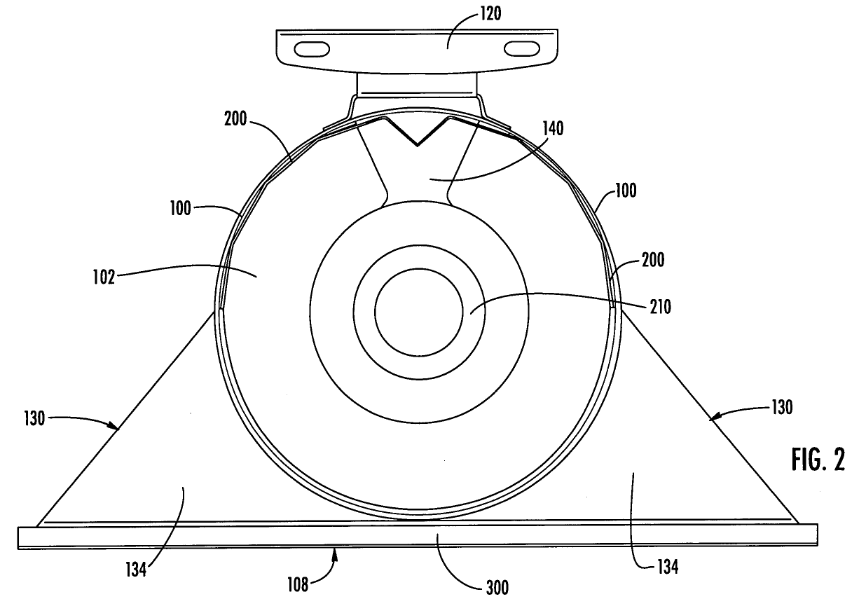

### Description FIG. 2:

FIG. 2 illustrates a front view of the device demonstrating the lamp socket 210 as seen through the first round hollow end 102. The lamp socket 210 is fixedly attached to the lamp socket bracket 140 and approximately centered within the hollow sheet metal tube 100. The second balancing suspender 120 and lamp socket bracket 140 may be connected in by screws, pop rivets, or any other connection method providing a pass through connection to the second balancing suspender 120, through the hollow sheet metal tube 100, and into the lamp socket bracket 140.

The reflector 130 has a series of reflector bends 200 positioned and angled to reflect light towards the plants while forming a shape that can fit within the hollow sheet metal tube 100. The second reflector end 134 bounds the reflector 130 and securely attaches to one end of the transparent portion 108.

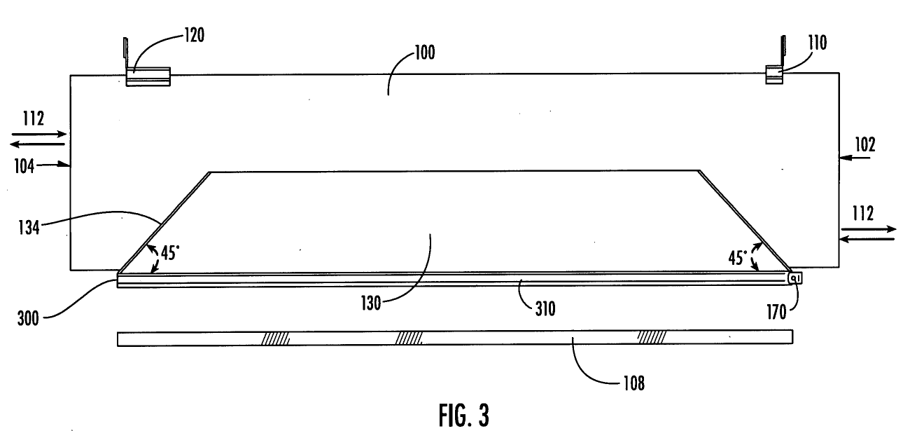

### Description FIG. 3:

FIG. 3 is a left side view of one embodiment of the Forced Air Cooled Metallic Tubular Horticulture Light Fixture as shown in FIG. 1. The hollow sheet metal tube 100 is constructed from a single sheet of metal having a first round hollow end 102 and a second round hollow end 104. The hollow sheet metal tube 100 is of a length adequate to house a commercially available grow lamp and accommodate the reflector 130 and first and second reflector ends 132, 134. The cooling atmosphere 112 may flow into the first round hollow end 102 and exhaust out of the second round hollow end 104; or, oppositely, the cooling atmosphere may flow into the second round hollow end 104 and exhaust out of the first round hollow end 102.

In the embodiment shown in FIG. 3, the first and second reflector ends 132, 134 bound the reflector 130 at approximately 45-degree angles. The reflector 130 is constructed and arranged to protrude from the hollow sheet metal tube 100, bisecting the hollow sheet metal tube 100 approximately in half, leaving enough of the hollow sheet metal tube 100 intact at the first and second round hollow ends 102, 104 for connection to round conduit.

The size, shape, angle, and materials used in construction of the reflector 130 and first and second reflector ends 132, 134 are determined by the desired photometric characteristics, light intensity, and grow lamp characteristics. The distance from the plants and the number of fixtures being utilized also drive the size, shape and angle of the reflector 130 and first and second reflector ends 132, 134.

A first balancing suspender 110 and second balancing suspender 120 fixedly attach on the top side of the sheet metal tube 100 providing structure to hang the device above the plants. The location of the first and second balancing suspenders 110, 120 is determined by the weight and balance of the device.

The retention flap 170 pivotally connects to the reflector 130 on the opposite edge as the channel formed by the second reflector end 134.

Cooling atmosphere 112 travels in a straight channel flow through the hollow sheet metal tube 100, and may be flowed into the first round hollow end 102 and exhausted out of the second round hollow end 104; or, oppositely, cooling atmosphere 112 can be flowed into the second round hollow end 104 and exhausted out the first round hollow end 102.

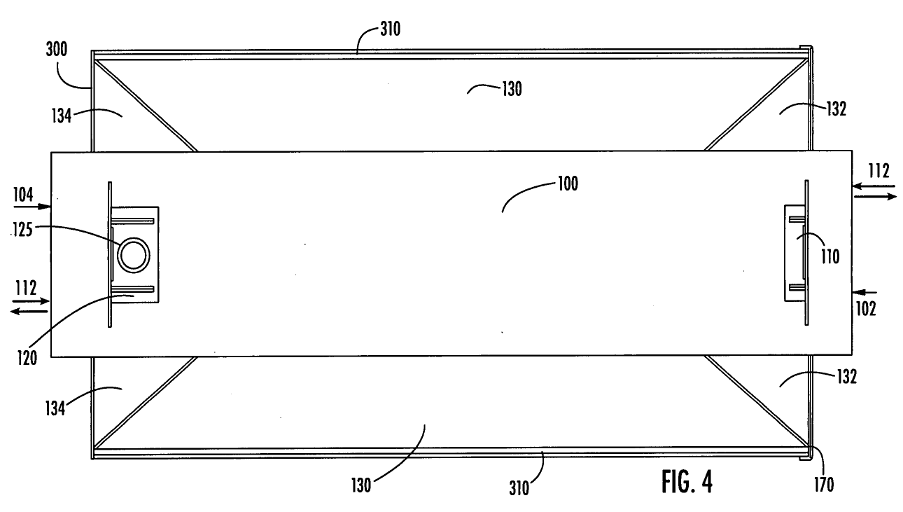

### Description FIG. 4:

FIG. 4 illustrates a top side view of one embodiment of the Forced Air Cooled Metallic Tubular Horticulture Light Fixture as shown in FIG. 1. The hollow sheet metal tube 100 is approximately centered with respect to the reflector 130. The first and second balancing suspenders 110, 120 are approximately centered on the hollow sheet metal tube 100 and distanced in from the first and second round hollow ends 102, 104 to facilitate connection to round conduit.

The second suspender hole 125 is located approximately above the previously shown lamp socket bracket 140 allowing access for an electrical service connection to the grow lamp.

In the preferred embodiment as shown, the transparent portion 108 is securely attached on the short ends via an end channel 300 formed by the second reflector end 134 and reflector side channels 310 and secured in place by the retention flap 170 on the opposite end of the end channel 300. The retention flap 170 is pivotally connected to the reflector 130. The reflector side channels 310 are bent, shaped, and formed from the same sheet as the reflector 130 and matched to the size and shape of the transparent portion 108. When installing the transparent portion 108, the transparent portion 108 is simply slid into the reflector side channels 310 formed by the reflector 130 until one short end fittingly inserts into the end channel 300 formed by the second reflector end 134, and securely held in place by the retention flap 170. The retention flap 170 pivotally connects to the reflector 130 allowing for easy removal of the transparent portion 108 for cleaning.

The method of securing a piece of flat glass is well known in the art and the inventive device is not limited by the method shown in the preferred embodiment.

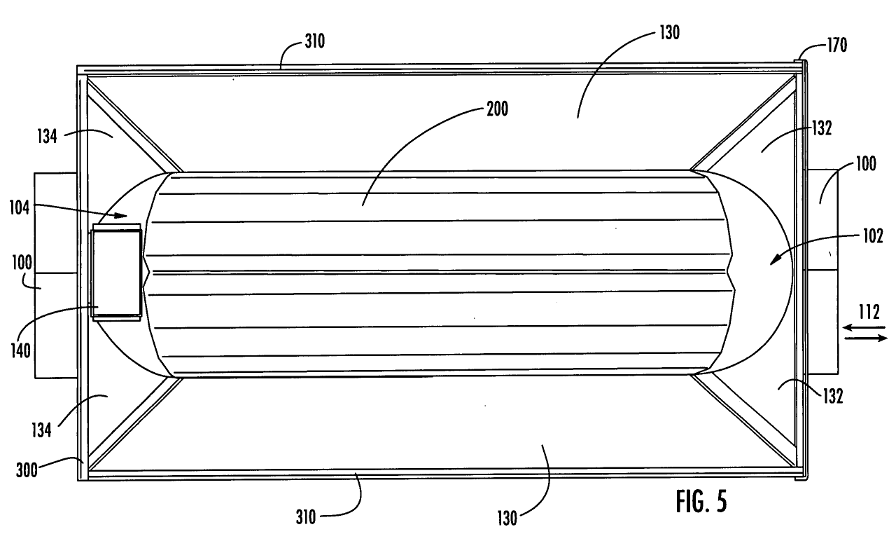

### Description FIG. 5:

FIG. 5 illustrates a bottom side view of one embodiment of the Forced Air Cooled Metallic Tubular Horticulture Light Fixture as shown in FIG. 1. The hollow sheet metal tube 100 is approximately centered with respect to the reflector 130. The reflector 130 is shaped and bent to reflect light towards the plants from the grow lamp while being fitted inside the hollow sheet metal tube 100. The first reflector end 132 is shaped to match the reflector 130 and has an opening approximately matching the first round hollow end 102. The retention flap 170 is pivotally connected to the reflector 130 and secures the transparent portion 108 by holding said transparent portion 108 in the reflector side channels 310 formed along the long edges of the reflector 130 and an end channel 300 formed along the edge of the second reflector end 134. The second reflector end 134 is shaped to match the reflector 130 and has an opening approximately matching the second round hollow end 104.

The lamp socket bracket 140 is centered within the second round hollow end 104 and positioned to locate the grow lamp under the reflector bends 200. The grow lamp may be located anywhere within the hollow sheet metal tube 100, but the preferred embodiment locates the grow lamp between the reflector bends 200 and the transparent portion 108.

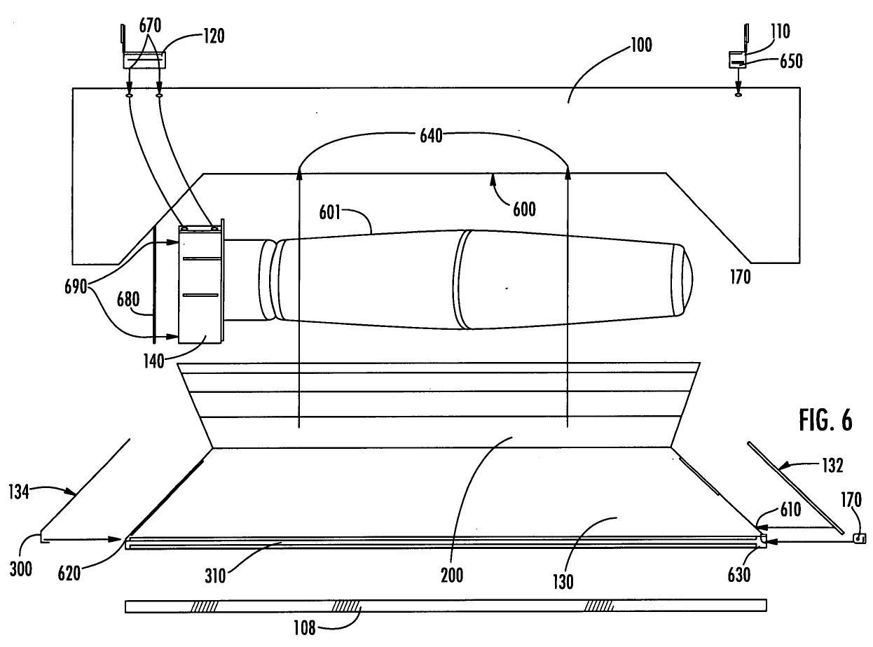

### Description FIG. 6:

FIG. 6 illustrates a right side exploded view of the preferred embodiment of the Forced Air Cooled Metallic Tubular Horticulture Light Fixture as shown in FIG. 1. The hollow sheet metal tube 100 has a cut-away portion 600 matching the shape and angle of the reflector 130. The reflector 130 and hollow sheet metal tube 100 attach at the reflector-to-tube connections 640. The first reflector end 132 and reflector 130 attach at the first reflector connection 610. The second reflector end 134 and reflector 130 attach at the second reflector connection 610. The bracket back plate 680 and lamp socket bracket 140 attach at bracket connection points 690. The lamp socket bracket 140, hollow sheet metal tube 100, and second balancing suspender 120, attach at the bracket-tube-suspender connection points 670. Attachment may be made via a bent over tab inserted into a punched out slot, a screw, heat resistant adhesive, or any other method allowing connection between the two pieces of sheet metal.

The retention flap 170 pivotally connects to the reflector 130 and is of size and shape matching the transparent portion 108. If a thicker transparent portion 108 is desired, the reflector side channels 310, end channel 300, and the retention flap 170 would be constructed having a size and shape matching the thicker transparent portion 108.

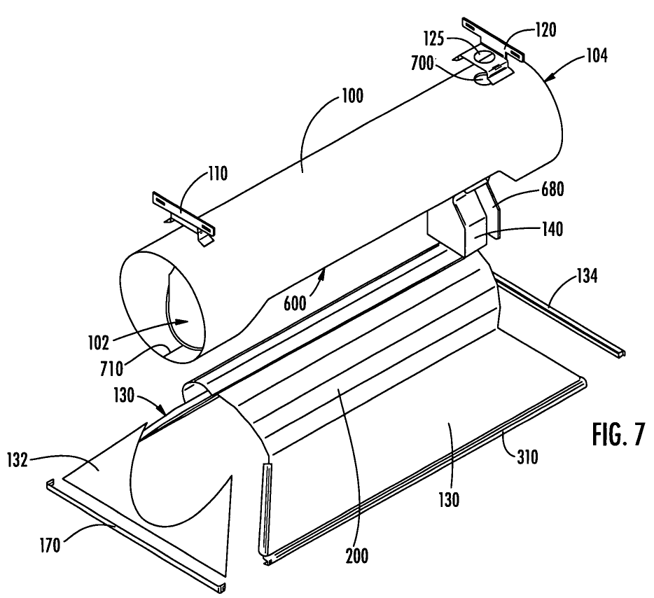

### Description FIG. 7:

FIG. 7 illustrates a perspective exploded view of the preferred embodiment of the Forced Air Cooled Metallic Tubular Horticulture Light Fixture as shown in FIG. 1. The hollow sheet metal tube 100 has a cut-away portion 600 matching the shape and angle of the reflector 130. In the embodiment shown the seam 710 is located along the bottom side of the hollow sheet metal tube 100. The bracket back plate 680 and lamp socket bracket 140 are not connected together until after the wiring is passed through the second suspender hole 125 and connected to the lamp socket 210.

The retention flap 170 pivotally connects to the reflector 130 and is of size and shape matching the transparent portion 108. The reflector side channels 310, end channel 300, and the retention flap 170 are constructed and arranged to match the size and dimension of the desired transparent portion 108

The hollow sheet metal tube 100 is approximately centered with respect to the reflector 130. The reflector 130 is shaped and bent to reflect light towards the plants from the grow lamp while being fitted inside the hollow sheet metal tube 100. The reflector bends 200 may be of any number, angle, and shape to match the desired photometric performance, distance of hanging from the plants, or the particular type of grow lamp to be installed. The first and second balancing suspenders 110 and 120 are attached along the top of the hollow sheet metal tube 100 and located to balance the device when hung.

The first reflector end 132 is shaped to match the reflector 130 and has an opening approximately matching the first round hollow end 102. The retention flap 170 is pivotally connected to the reflector 130 and secures the transparent portion 108 by holding said transparent portion in the reflector side channels 310 formed along the long edges of the reflector 130 and an end channel 300 formed along the edge of the second reflector end 134. The second reflector end 134 is shaped to match the reflector 130 and has an opening approximately matching the second round hollow end 104.

The lamp socket bracket 140 is centered within the second round hollow end 104 and positioned to locate the grow lamp 601 under the reflector bends 200. The grow lamp 601 may be located anywhere within the hollow sheet metal tube 100, but the preferred embodiment locates the grow lamp 601 between the reflector bends 200 and the transparent portion 108.

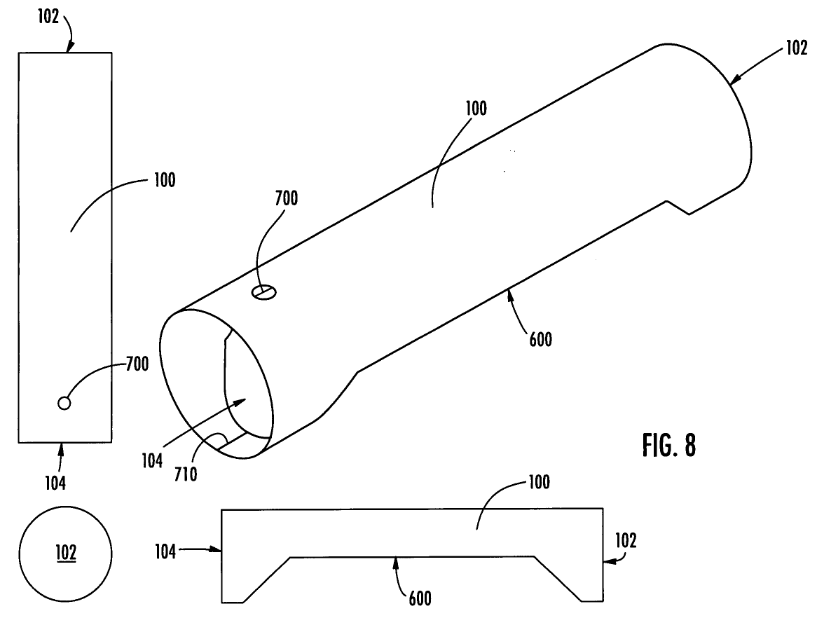

### Description FIG. 8:

FIG. 8 illustrates a perspective, side, top and end view of the hollow sheet metal tube 100 as shown in FIG. 1. The sheet metal tube 100 is formed from a single sheet of metal having a first round hollow end 102 and a second hollow end 104. The electrical power inlet 700 can be located anywhere, but for the preferred embodiment the electrical power inlet 700 is located on the top side where the inventor anticipates electrical service. The cut-away portion 600 can be of any size, shape, and location along the hollow sheet metal tube 100 so long as the cut-away portion 600 matches the size and shape of the reflector 130, and enough of the hollow sheet metal tube 100 extends beyond the cut-away portion 600 to allow for slide over connection to round conduit. The sheet metal seam 710 is located along the bottom of the hollow sheet metal tube 100 in the preferred embodiment, but may be located anywhere convenient to manufacturing.

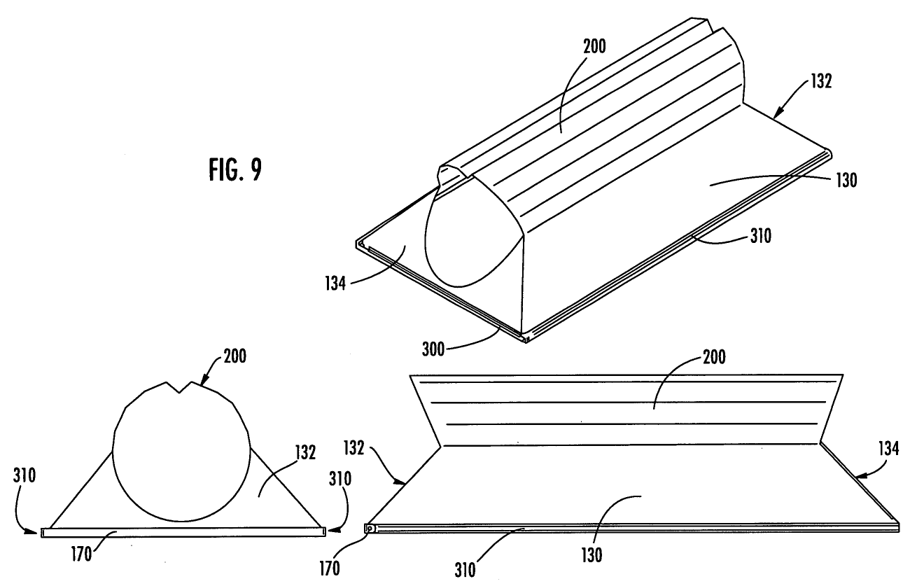

### Description FIG. 9:

FIG. 9 illustrates a perspective, side, and end view of the reflector 130, first reflector end 132, second reflector end 134, and the retention flap 170 as assembled and shown in previous FIGS. 1-8.

The reflector side channels 310 are formed from the bottom long edges of the reflector 130, sized to match the thickness of the desired transparent portion 108. The end channel 300 is formed from the bottom edge of the second reflector end 134, sized to match the thickness of the transparent portion 108 shown in earlier Figures. The reflector bends 200 produce the desired photometric performance of the reflector 130, and can be either many or one. The retention flap 170 pivotally connects to the reflector 130 and is of size and shape matching the transparent portion 108.

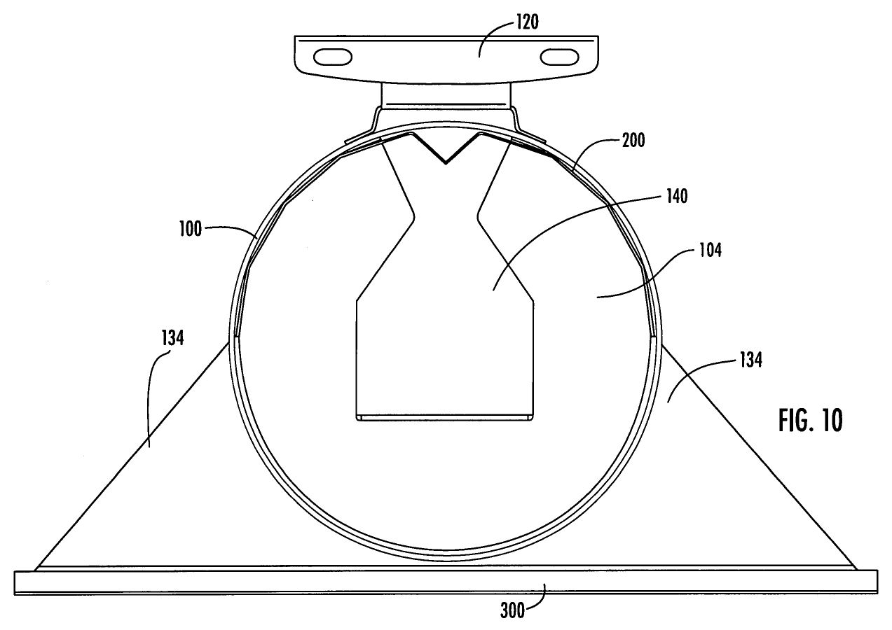

### Description FIG. 10:

FIG. 10 illustrates a rear view of the preferred embodiment depicting the lamp socket bracket 140 as seen through the second round hollow end 104. The lamp socket bracket is approximately centered within the hollow sheet metal tube 100. The lamp socket bracket 140 may be connected to the hollow sheet metal tube via screws, pop rivets, or some other attachment method that pass through the second balancing suspender 120, through the hollow sheet metal tube 100, through the reflector 130, and attaching to the lamp socket bracket 140.

The second reflector end 134 is shaped to match the reflector 130 and has an opening approximately matching the second round hollow end 104. The transparent portion 108 is held in place by the reflector side channels 310 formed along the long edges of the reflector 130 and an end channel 300 formed along the bottom edge of the second reflector end 134.

1-2. (canceled)

3. A horticultural light apparatus for reducing the temperature impact of the lamp on the growing plants comprising:
a hollow sheet metal tube, having first and second round hollow ends and a cutaway portion on the underside open towards the plants;
a lamp:
at least one lamp socket mounted within said metallic tube, locating the lamp over the cutaway portion;
a reflector mounted within the metallic tube and extending out through the cutaway portion, constructed and arranged to deflect light from the lamp toward the plants;
a transparent portion fittingly attached to the reflector between the lamp and the plants;
a cooling atmosphere flowed into said first round hollow end and out said second round hollow end.

4. The horticulture light apparatus of claim 3 wherein said cooling atmosphere flows in said second round hollow end and out said first round hollow end.
